(19) United States
(12) Patent Application Publication
(10) Pub. No.: US 2020/0055367 A1
(43) Pub. Date: Feb. 20, 2020

(54) Air Conditioner Platform Structure and Vehicle with Air Conditioner Platform Structure

(71) Applicant: CRRC QINGDAO SIFANG CO., LTD., Qingdao (CN)

(72) Inventors: Yang LI, Qingdao (CN); Chunlei GU, Qingdao (CN); Yongfeng TAI, Qingdao (CN); Yingcan HU, Qingdao (CN); Honglei TIAN, Qingdao (CN); Yuanmu ZHONG, Qingdao (CN); Sansan DING, Qingdao (CN); Yuwen LIU, Qingdao (CN); Jianying LIANG, Qingdao (CN); Guidong TAO, Qingdao (CN); Aiqin TIAN, Qingdao (CN)

(21) Appl. No.: 16/346,191

(22) PCT Filed: Sep. 30, 2017
(86) PCT No.: PCT/CN2017/104830

§ 371 Date: Apr. 30, 2019

(30) Foreign Application Priority Data
Dec. 1, 2016 (CN) 201611093214.3

(51) Int. Cl. B60H 1/00

(52) U.S. Cl. CPC B60H 1/00535

(57) ABSTRACT

Provided are an air conditioner platform structure and a vehicle having the same. The air condition platform structure comprises a platform main body for mounting an air conditioner, the platform main body comprises a plurality of beam bodies, and the plurality of beam bodies are spliced in sequence in a circumferential direction along the platform main body to form a frame structure for supporting the air conditioner.

### TECHNICAL FIELD

The disclosure relates to a field of vehicles, and in particular to an air conditioner platform structure and a vehicle with the air conditioner platform structure.

### BACKGROUND

In a related subway, a subway air conditioner platform is of a complex structure, a water drainage device needs to be independently mounted, and thus the overall weight of the subway is increased.

In addition, a related air conditioner mounting base is an independent small base, the air conditioner mounting base is mounted on a platform in an electric arc welding mode, large material welding deformation may be caused by great welding workloads, and overall planeness of mounting bases is hard to ensure.

### SUMMARY

Some embodiments of the present disclosure provide an air conditioner platform structure and a vehicle with the air conditioner platform structure, solving the problem that a subway air conditioner platform structure in the related art has a large weight.

To achieve the purpose, an embodiment of the present disclosure provides an air conditioner platform structure, the air conditioner platform structure includes a platform main body for mounting an air conditioner, the platform main body includes a plurality of beam bodies, and the plurality of beam bodies are spliced in sequence in a circumferential direction along the platform main body to form a frame structure for supporting the air conditioner.

In an exemplary embodiment, the plurality of beam bodies include two mounting beams, the two mounting beams are oppositely provided, and the two mounting beams are used for supporting the air conditioner.

In an exemplary embodiment, the plurality of beam bodies further include an end beam, and the end beam is provided between the two mounting beams.

In an exemplary embodiment, two end beams are provided, and one end beam in the two end beams is connected to one end of each of the two mounting beams, the other end beam is connected to the other end of the each of the two mounting beams.

In an exemplary embodiment, the plurality of beam bodies include a first reinforcing beam, and an outer side of at least one of the two end beams has the first reinforcing beam.

In an exemplary embodiment, each of the two end beam includes a vertical plate part and a transverse plate part which are mutually connected, a part of beam body of the first reinforcing beam is connected with the vertical plate part, and a part of beam body of the first reinforcing beam is connected with the transverse plate part.

In an exemplary embodiment, the plurality of beam bodies include a waterproof plate for forming a waterproof groove, and the waterproof plate is provided on an inner side of the end beam.

In an exemplary embodiment, the end beam includes a vertical plate part and a transverse plate part which are mutually connected, a baffle plate part is provided on the transverse plate part, the baffle plate part is provided parallel to the vertical plate part, the waterproof plate is provided on the transverse plate part, and the waterproof groove is surrounded by the waterproof plate, the transverse plate part and the baffle plate part.

In an exemplary embodiment, the plurality of beam bodies further include two side beams, each of the two side beams is provided on a corresponding mounting beam of the two mounting beams, an extension direction of the each of the two side beams is identical to an extension direction of the corresponding mounting beam, and a rectangular frame used for connecting with a vehicle body is surrounded by two end beams and the two side beams.

In an exemplary embodiment, the plurality of beam bodies further include a second reinforcing beam, the second reinforcing beam is provided on a side far away from a corresponding mounting beam in the two mounting beams, of each of the two side beams, and an extension direction of the second reinforcing beam is identical to an extension direction of the side corresponding beam.

Another embodiment of the present disclosure provided a vehicle, the vehicle includes a vehicle body and an air conditioner platform structure provided on the vehicle body, and the air conditioner platform structure being the above air conditioner platform structure.

As the platform main body of the air conditioner platform structure is of a frame structure spliced by the plurality of beam bodies, the structure of an air conditioner platform is simplified, lightening of the air conditioner platform is achieved, the platform main body is also prevented from a ponding phenomenon, and the problem that the air conditioner platform structure of a subway in the related art has a large weight is solved.

### BRIEF DESCRIPTION OF THE DRAWINGS

A part of drawings of the disclosure are provided to further understand the disclosure, and schematic embodiments and description are adopted not to limit the disclosure but only to explain the disclosure. In the drawings:

FIG. 1 illustrates a structure diagram of an air conditioner platform structure according to an embodiment of the disclosure;

FIG. 2 illustrates a top view of the air conditioner platform structure of FIG. 1;

FIG. 3 illustrates a section view A-A of the air conditioner platform structure of FIG. 2;

FIG. 4 illustrates a mounting schematic diagram of a section view B-B of the air conditioner platform structure of FIG. 2;

FIG. 5 illustrates a partial view of the air conditioner platform structure of FIG. 3.

Herein, the drawings include the following drawing markers:

10: platform main body; 20: mounting beam; 30: end beam; 31: vertical plate part; 32: transverse plate part; 33: baffle plate part; 40: first reinforcing beam; 50: waterproof plate; 51: waterproof groove; 60: side beam; 70: second reinforcing beam.

### DETAILED DESCRIPTION OF THE EMBODIMENTS

It needs to be noted that embodiments and characteristics of the embodiments of the disclosure may by mutually combined without confliction, and the disclosure is described in details with the drawings and the embodiments.

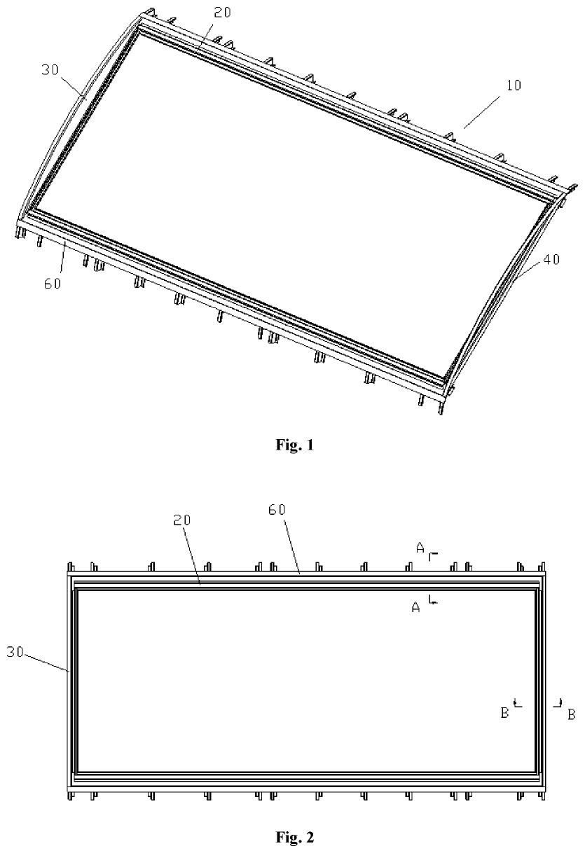

Some embodiments of the present disclosure provide an air conditioner platform structure. As shown in FIG. 1 to FIG. 4, the air conditioner platform structure includes a platform main body 10 for mounting an air conditioner, the platform main body 10 includes plurality of beam bodies, and the plurality of beam bodies are spliced in sequence in a circumferential direction along the platform main body 10 to form a frame structure for supporting the air conditioner.

As the platform main body 10 of the air conditioner platform structure of the disclosure is of a frame structure spliced by the plurality of beam bodies, the structure of an air conditioner platform is simplified, lightening of the air conditioner platform is achieved, the platform main body 10 is also prevented from a ponding phenomenon, and the problem that the air conditioner platform structure of a subway in the related art has a large weight is solved.

In an exemplary embodiment, as shown in FIG. 1 to FIG. 3, the plurality of beam bodies include two mounting beams 20, the two mounting beams 20 are oppositely provided, and the two mounting beams 20 are used for supporting the air conditioner. The air conditioner may be conveniently supported by providing the mounting beams 20.

In addition, the plurality of beam bodies further include an end beam 30, and the end beam 30 is provided between the two mounting beams 20. In this way, the two opposite mounting beams 20 are connected by the end beams 30.

In an exemplary embodiment, two end beams 30 are provided, and one end beam 30 in the two end beams 30 is connected to one end of each of the two mounting beams 20, the other end beam 30 is connected to the other end of the each of the two mounting beams 20. In this way, the two mounting beams 20 and the two end beams 30 form a rectangular frame structure. The end beams 30 are connected with a top plate of a vehicle body.

To improve the strength of the end beams 30, as shown in FIG. 1 and FIG. 4, the plurality of beam bodies include a first reinforcing beam 40, and an outer side of at least one of the two end beams 30 has the first reinforcing beam 40. In this way, the outer side of the end beam 30 refers to a side far away from the other end beam 30 of the two end beams 30.

In an exemplary embodiment, each of the end beams 30 includes a vertical plate part 31 and a transverse plate part 32 which are mutually connected, a part of beam body of the first reinforcing beam 40 is connected with the vertical plate part 31, and a part of beam body of the first reinforcing beam 40 is connected with the transverse plate part 32. In an exemplary embodiment, the vertical plate part 31 and the transverse plate part 32 of the end beam 30 form an L-shaped structure, the transverse plate part 32 is positioned on an inner side of the vertical plate part 31. The first reinforcing beam 40 is a bent plate, the first reinforcing beam 40 is composed of a first L-shaped plate and a second L-shaped plate, a first plate section of the first L-shaped plate is connected with the vertical plate part 31, a second plate section of the first L-shaped plate extends in a direction far away from the vertical plate part 31, a first plate section of the second L-shaped plate is connected with the second plate section of the first L-shaped plate, and a second plate section of the second L-shaped plate is connected with the transverse plate part 32.

To achieve a waterproof function, as shown in FIG. 4, the plurality of beam bodies further include a waterproof plate 50 for forming a waterproof groove 51, and the waterproof plate 50 is provided on an inner side of the end beam 30. That is, the waterproof plate 50 is provided on a side close to the other end beam 30 of the end beam 30.

The plurality of beam bodies include two waterproof plates 50, each of the two waterproof plates 50 is provided on the inner side of the corresponding end beam 30 in the two end beams 30.

In an exemplary embodiment, the end beams 30 include a vertical plate part 31 and a transverse plate part 32 which are mutually connected, a baffle plate part 33 is provided on the transverse plate part 32, the baffle plate part 33 is provided parallel to the vertical plate part 31, the waterproof plate 50 is provided on the transverse plate part 32, and the waterproof groove is surrounded by the waterproof plate 50, the transverse plate part 32 and the baffle plate part 33. Therefore, accumulated water is deposited into the waterproof grooves 51 and is prevented from damaging the air conditioner in the frame structure.

To ensure a connecting effect of the air condition platform structure with the vehicle body, the plurality of beam bodies further include two side beams 60, each of the two side beams 60 is provided on a corresponding mounting beam 20 in the two mounting beams, an extension direction of the each of the two side beams 60 is identical to an extension direction of the corresponding mounting beam 20, and a rectangular frame used for connecting with a vehicle body is surrounded by two end beams 30 and the two side beams 60. In the rectangle frame, the side beams 60 form long sides of the rectangular frame. In an exemplary embodiment, each of the two side beams 60 is provided on an outer side of the corresponding mounting beams 20, then the side beams 60 are conveniently connected with the top plate of the vehicle body, and the air conditioner is well supported by the mounting beams 20.

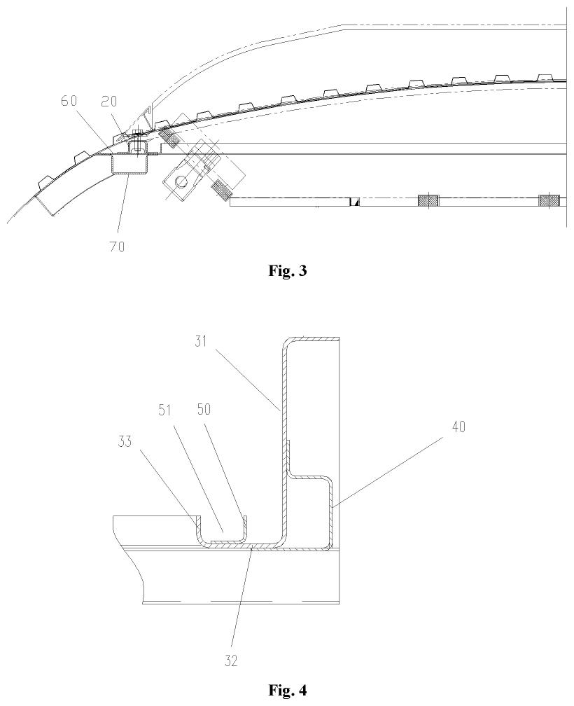

FIG. 5 illustrates a partial view of the air conditioner platform structure of FIG. 3.

To improve the strength of the side beams 60, as shown in FIG. 3 and FIG. 5, the plurality of beam bodies further include a second reinforcing beam 70, the second reinforcing beam 70 is provided on a side far away from a corresponding mounting beams 20, in the two mounting beams, of each of the two side beams 60, and an extension direction of the second reinforcing beam 70 is identical to an extension direction of the side beam 60. In an exemplary embodiment, the second reinforcing beam 70 is provided on a side far away from the corresponding mounting beam 20 of the two mounting beams 20, of the corresponding side beam 60 of the two side beams 60. In an exemplary embodiment, the second reinforcing beam 70 and the mounting beam 20 are both of “n”-shaped, that is, each of the second reinforcing beams 70 and the mounting beams 20 includes a U-shaped plate and connecting plates which are provided at two ends of the opening of the U-shaped plate, and the two connecting plates extend in a direction far away from the opening of the U-shaped plate.

Some embodiments of the present disclosure further provide a vehicle, the vehicle includes a vehicle body and an air conditioner platform structure which is provided on the vehicle body, and the air conditioner platform structure being above the air conditioner platform structure.

The air conditioner platform structure disclosed by the scheme of the disclosure mainly consists of stainless steel rollers and stamping parts in a resistance electric welding manner, a small amount of components are used, a structure of a air conditioner platform in related art is simplified, and the weight is reduced.

The air conditioner platform is of a frame holding structure consisting of components such as end beams, cap-shaped mounting beams, and cap-shaped reinforcing beams in a resistance spot welding manner, the platform mainly adopts the resistance spot welding, then small welding deformation is caused, cap-shaped beam holding structures are used at main holding parts, and high rigidity and strength may be achieved.

The air conditioner end beams and the reinforcing beams are welded in a resistance spot welding manner to form an air conditioner end top, and air conditioner side beams, air conditioner mounting beams and the reinforcing beams are welded in the resistance spot welding manner, so that welding deformation is reduced, and straightness and planeness of the air conditioner mounting beams are ensured; due to a structure of the two cap-shaped reinforcing beams, strength and rigidity of the air conditioner platform are improved. In addition, air conditioner mounting sliding blocks are pre-mounted in the air conditioner mounting beams, and later air conditioner mounting is facilitated. After the waterproof plates are welded with the end beams, sealed mounting grooves are formed in an air conditioner inner frame, and thus sealing performance is ensured after the air conditioner is mounted.

The air conditioner platform structure of some embodiments of the disclosure has the following advantages:
1. Compared with the air conditioner platform in related, the structure of an embodiment in the present disclosure is simple, and lightening is achieved;
2. Due to adoption of a non-sunk bearing structure, the platform has no water ponding, so that no water drainage tube needs to be independently provided, and the construction process is simple;
3. The air conditioner mounting base is mounted in a mode which is completely different from a mode in related art, and an overall cap-shaped mounting beam is provided on the platform, so that the planeness of a mounting surface is easily ensured, and meanwhile, due to the cap-shaped mounting beam, the rigidity and the strength of the air conditioner platform are very well improved;
4. A sliding block is pre-mounted in the air conditioner mounting beam, and thus later air conditioner mounting is facilitated;
5. After the overall platform is welded, a platform inner frame forms a closed mounting groove which is beneficial to mounting and sealing of the air conditioner.

The description shows that embodiments of the disclosure have the following technical effects.

According to the disclosure, as the platform main body of the air conditioner platform structure is of the frame structure spliced by the plurality of beam bodies, the structure of the air conditioner platform is simplified, lightening of the air conditioner platform is achieved, the platform main body is also prevented from the ponding phenomenon, and the problem that the air conditioner platform structure of a subway in the related art has large weight in the conventional art is solved.

The above is only the optional embodiment of the disclosure and not intended to limit the scope of protection of the disclosure. For those skilled in the art, the disclosure may have various modifications and variations. Any modifications, equivalent replacements, improvements and the like made within the spirit and principle of the invention shall fall within the scope of protection of the disclosure.

1. An air conditioner platform structure, comprising a platform main body for mounting an air conditioner, the platform main body comprises a plurality of beam bodies, and the plurality of beam bodies are spliced in sequence in a circumferential direction along the platform main body to form a frame structure for supporting the air conditioner.

2. The air conditioner platform structure as claimed in claim 1, wherein the plurality of beam bodies comprise two mounting beams, the two mounting beams are oppositely provided, and the two mounting beams are used for supporting the air conditioner.

3. The air conditioner platform structure as claimed in claim 2, wherein the plurality of beam bodies further comprise an end beam, and the end beam is provided between the two mounting beams.

4. The air conditioner platform structure as claimed in claim 3, wherein two end beams are provided, and one end beam in the two end beams is connected to one end of each of the two mounting beams, the other end beam is connected to the other end of the each of the two mounting beams.

5. The air conditioner platform structure as claimed in claim 4, wherein the plurality of beam bodies comprise a first reinforcing beam and an outer side of at least one of the two end beams has the first reinforcing beam.

6. The air conditioner platform structure as claimed in claim 5, wherein each of the two end beams comprises a vertical plate part and a transverse plate part which are mutually connected, a part of beam body of the first reinforcing beam is connected with the vertical plate part, and a part of beam body of the first reinforcing beam is connected with the transverse plate part.

7. The air conditioner platform structure as claimed in claim 3, wherein the plurality of beam bodies comprise a waterproof plate for forming a waterproof groove, and the waterproof plate is provided on an inner side of the end beam.

8. The air conditioner platform structure as claimed in claim 7, wherein the end beam comprises a vertical plate part and a transverse plate part which are mutually connected, a baffle plate part is provided on the transverse plate part, the baffle plate part is provided parallel to the vertical plate part, the waterproof plate is provided on the transverse plate part, and the waterproof groove is surrounded by the waterproof plate, the transverse plate part and the baffle plate part.

9. The air conditioner platform structure as claimed in claim 3, wherein the plurality of beam bodies further comprise two side beams, each of the two side beams is provided on a corresponding mounting beam of the two mounting beams, an extension direction of the each of the two side beams is identical to an extension direction of the corresponding mounting beam, and a rectangular frame used for connecting with a vehicle body is surrounded by two end beams and the two side beams.

10. The air conditioner platform structure as claimed in claim 9, wherein the plurality of beam bodies further comprise a second reinforcing beam, the second reinforcing beam is provided on a side far away from a corresponding mounting beam in the two mounting beams, of each of the two side beams, and an extension direction of the second reinforcing beam is identical to an extension direction of the corresponding side beam.

11. A vehicle, comprising a vehicle body and an air conditioner platform structure provided on the vehicle body, wherein the air conditioner platform structure being the air conditioner platform structure as claimed in of claim 1.

12. A vehicle, comprising a vehicle body and an air conditioner platform structure provided on the vehicle body, wherein the air conditioner platform structure is the air conditioner platform structure as claimed in claim 2.

13. A vehicle, comprising a vehicle body and an air conditioner platform structure provided on the vehicle body, wherein the air conditioner platform structure is the air conditioner platform structure as claimed in claim 3.

14. A vehicle, comprising a vehicle body and an air conditioner platform structure provided on the vehicle body, wherein the air conditioner platform structure is the air conditioner platform structure as claimed in claim 4.

15. A vehicle, comprising a vehicle body and an air conditioner platform structure provided on the vehicle body, wherein the air conditioner platform structure is the air conditioner platform structure as claimed in claim 5.

16. A vehicle, comprising a vehicle body and an air conditioner platform structure provided on the vehicle body, wherein the air conditioner platform structure is the air conditioner platform structure as claimed in claim 6.

17. A vehicle, comprising a vehicle body and an air conditioner platform structure provided on the vehicle body, wherein the air conditioner platform structure is the air conditioner platform structure as claimed in claim 7.

18. A vehicle, comprising a vehicle body and an air conditioner platform structure provided on the vehicle body, wherein the air conditioner platform structure is the air conditioner platform structure as claimed in claim 8.

19. A vehicle, comprising a vehicle body and an air conditioner platform structure provided on the vehicle body, wherein the air conditioner platform structure is the air conditioner platform structure as claimed in claim 9.

20. A vehicle, comprising a vehicle body and an air conditioner platform structure provided on the vehicle body, wherein the air conditioner platform structure is the air conditioner platform structure as claimed in claim 10.
